(19) United States
(12) Patent Application Publication
(10) Pub. No.: US 2024/0091849 A1
(43) Pub. Date: Mar. 21, 2024

(54) ADDITIVELY MANUFACTURED CHANNELS FOR MOLD DIE CASTINGS

(71) Applicant: The Boeing Company, Chicago, IL (US)

(72) Inventors: Michael A. Johnson, Kirkland, WA (US); Michael P. Matlack, St. Charles, MO (US); Daniel J. Smolinsky, Mill Creek, WA (US)

(73) Assignee: The Boeing Company, Chicago, IL (US)

(21) Appl. No.: 17/933,942

(22) Filed: Sep. 21, 2022

(51) Int. Cl. B22D 19/00; B22D 25/02

(52) U.S. Cl. CPC B22D 19/0072; B22D 19/0009; B22D 19/0081; B22D 25/02; B33Y 80/00

(57) ABSTRACT

A method for manufacturing a tool having one or more internal channels includes forming one or more channel cores by additive manufacturing, coating a metal onto the one or more channel cores to form a metal tube on each of the one or more channel cores, positioning the one or more metal tubes into a casting mold having a shape of a tool, and casting a molten metal into the casting mold to form the tool having the one or more internal channels corresponding to the one or more channel cores.

### FIELD

The present application relates to the field of tools having internal channels, as well as to methods for manufacturing tools having internal channels.

### BACKGROUND

Tools for manufacturing, such as metal forming/shaping tools or composite manufacturing tools, may be heated during the manufacturing process to cure pre-impregnated thermosets. Internal channels may be provided within such tools to provide a uniform tool surface temperature. A heated material, such as pressurized water (e.g., liquid water), propylene glycol, or steam, may flow through the channels to heat the tool.

A conformal channel approach may be used to improve manufacturing of pre-impregnated composites by providing more uniform heating of a tool surface. A conformal channel approach provides internal passages that generally conform to or follow the contour of a surface of the tool. Since the surface of a tool may have a complex shape, it can be challenging to provide conformal passages in a desired location within the tool.

Accordingly, those skilled in the art continue with research and development in the field of tools for manufacturing, which have internal channels, as well as in the field of methods for manufacturing tools having internal channels.

### SUMMARY

Disclosed are methods for manufacturing a tool having one or more internal channels.

In one example, the method includes forming one or more channel cores by additive manufacturing, coating a metal onto the one or more channel cores to form a metal tube on each of the one or more channel cores, positioning the one or more metal tubes into a casting mold having a shape of a tool, and casting a molten metal into the casting mold to form the tool having the one or more internal channels corresponding to the one or more channel cores.

In another example, the method includes forming one or more channel cores by additive manufacturing, positioning the one or more channel cores into a casting mold having a shape of a tool, and casting a molten metal into the casting mold to form the tool having the one or more internal channels corresponding to the one or more channel cores.

Also disclosed are tools that include a tool body comprising a surface, the surface comprising a surface contour, and a conforming internal channel having one or more directional changes and following the surface contour of the surface of the tool.

Other examples of the disclosed tools having internal channels and methods for manufacturing tools will become apparent from the following detailed description, the accompanying drawings and the appended claims.

### BRIEF DESCRIPTION OF THE DRAWINGS

FIG. 1 is a flow diagram of an exemplary method for manufacturing a tool having an internal channel according to an example of the present description.

FIG. 2 is a flow diagram of another exemplary method for manufacturing a tool having an internal channel according to an example of the present description.

FIG. 3A is an illustration of a first exemplary channel core according to the present description.

FIG. 3B is an illustration of a cross section of the channel core of FIG. 3A.

FIG. 4A is an illustration of a second exemplary channel core according to the present description.

FIG. 4B is an illustration of a cross section of the channel core of FIG. 4A.

FIG. 5A is an illustration of a third exemplary channel core according to the present description.

FIG. 5B is an illustration of a cross section of the channel core of FIG. 5A.

FIG. 6A is an illustration of a third exemplary channel core according to the present description.

FIG. 6B is an illustration of a cross section of the channel core of FIG. 6A.

FIGS. 7 and 8 are illustrations of a first exemplary casting mold according to the present description.

FIG. 9 is an illustration of a second exemplary casting mold according to the present description.

FIG. 10 is an illustration of an exemplary tool according to the present description.

FIG. 11 is a cross section of the tool of FIG. 10.

### DETAILED DESCRIPTION

This disclosure relates to tools having internal channels and methods for manufacturing such tools.

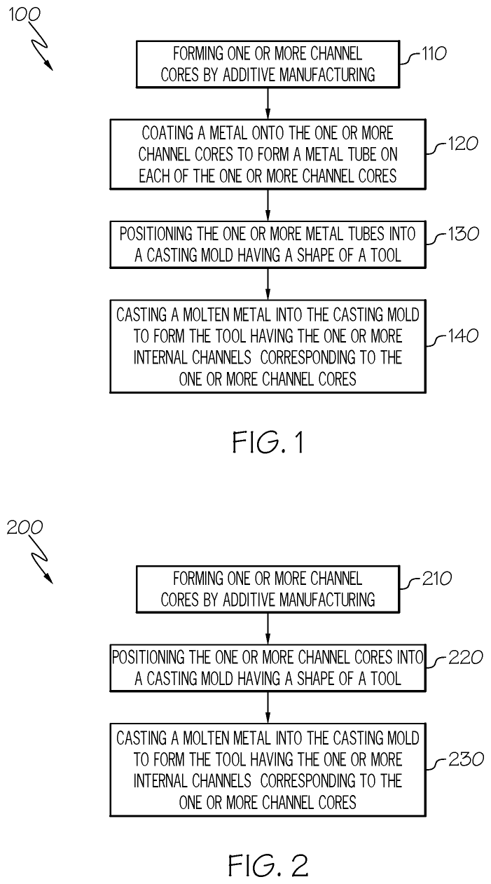

FIG. 1 is a flow diagram of an exemplary method 100 for manufacturing a tool having a channel according to the present description. The method 100 includes forming one or more channel cores by additive manufacturing at block 110, coating metal onto the one or more channel cores to form a metal tube on each of the one or more channel cores at block 120, positioning the one or more metal tubes into a casting mold having a shape of a tool at block 130, and casting a molten metal into the casting mold to form the tool, wherein the tool has one or more internal channels corresponding to the one or more metal tubes at block 140.

FIG. 2 is a flow diagram of another exemplary method 200 for manufacturing a tool having a channel according to the present description. The method 200 includes forming one or more channel cores by additive manufacturing at block 210, positioning the one or more channel cores into a casting mold having a shape of a tool at block 220, and casting a molten metal into the casting mold to form the tool having the one or more internal channels corresponding to the one or more channel cores at block 230.

The channel core may be formed from any material suitable for forming by additive manufacturing. In particular, the channel core may include a polymer binder. In the case of casting a molten metal having a high melting temperature, the channel core may include a high temperature polymer binder, such as a phenolic binder, e.g., furan resin. Additionally, the channel core may include a higher temperature inorganic material, such as a refractory. For example, the channel core may include a refractory and a high temperature polymer binder, such as phenolic binder, as a binder for binding the refractory. An exemplary refractory may include a ceramic sand, such as sodium silicate.

The channel core may include a first end, a second end, and a cross-section. The cross-section of the channel core should correspond with an internal channel to be formed in the resulting tool. The cross-section of the channel core and may be, for example, a round cross-section or an oval cross-section. Further, the channel core may have, for example, a solid cross-section or a hollow cross-section.

Between the first end and the second end of the channel core, the channel core may include one or more directional changes. The directional changes may facilitate a conformal channel approach for provides internal channels that generally conform to or follow the surface contour of a surface of a resulting tool.

The channel core may further include one or more exterior reinforcements. The exterior reinforcements may help the channel core maintain a desired shape and position within the casting mold during a high temperature casting process that may tend to deform the channel core.

Forming the channel core by an additive manufacturing process facilitates providing a channel core having a complex shape to thereby provide complex conformal internal channels in a desired location within the tool and to provide exterior reinforcements to help the channel core maintain a desired shape and position within the casting mold. The channel core may be formed by any suitable additive manufacturing process. In an example, the channel core may be formed by a powder-based additive manufacturing method, such as selective laser sintering, electron beam melting, selective laser melting, etc. In another example, the channel core may be formed by filament-based additive manufacturing method, such as fused filament fabrication.

A powder-based additive manufacturing method may be particularly suitable for forming a channel core from a composite material of a high temperature polymer binder, such as a phenolic binder, and a higher temperature inorganic material, such as a refractory.

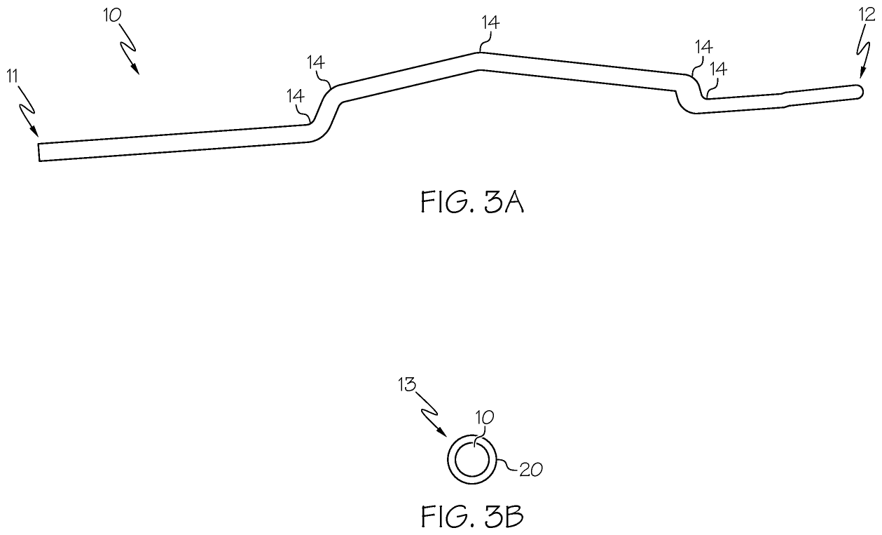

FIGS. 3 to 6 illustrate exemplary coated channel cores 10 according to the present description. The present description includes these channel cores as well as variations therefrom.

FIGS. 3A and 3B are illustrations of a first exemplary channel core 10 according to the present description. The channel core 10 has a first end 11, a second end 12, a solid, round cross-section 13, and directional changes 14. As shown in FIG. 3B, the channel core 10 has a solid, round cross-section 13. As shown in FIG. 3B, the channel core 10 has a solid, round cross-section 13.

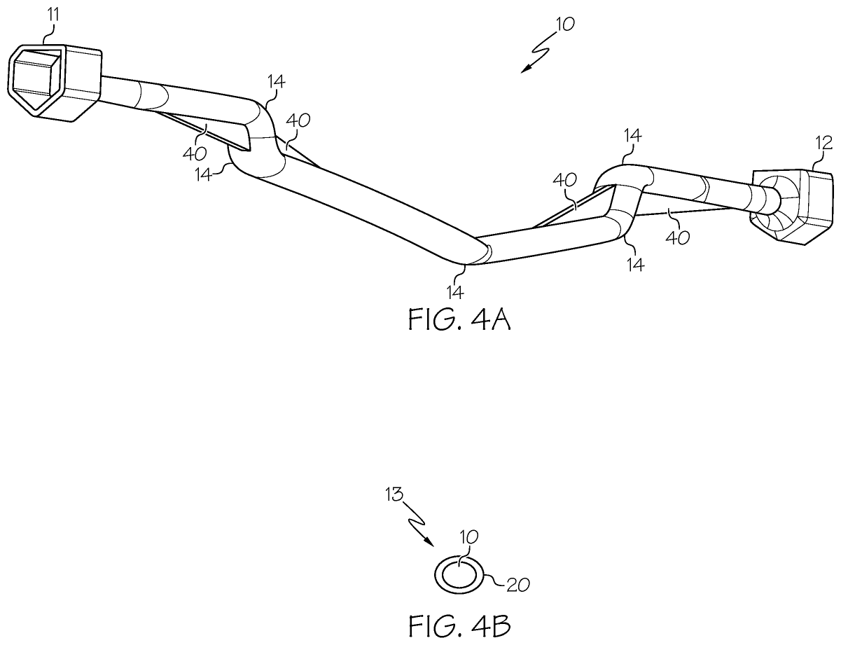

FIGS. 4A and 4B are illustrations of a second exemplary channel core 10 according to the present description. The channel core 10 has a first end 11, a second end 12, a solid, oval cross-section 13, and directional changes 14. The channel core 10 further comprises exterior reinforcements 40. As shown in FIG. 4B, the channel core 10 has a solid, oval cross-section 13.

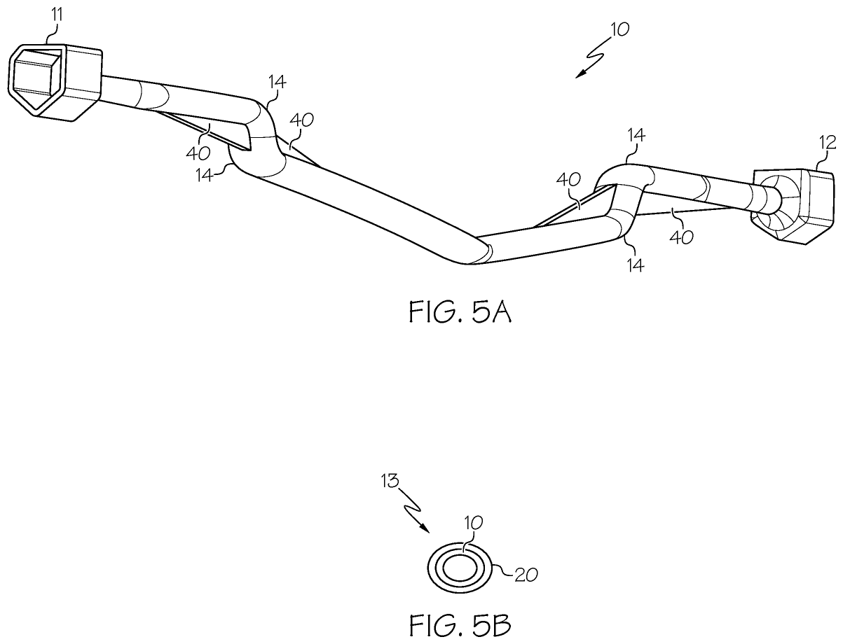

FIGS. 5A and 5B are illustrations of a third exemplary channel core 10 according to the present description. The channel core 10 has a first end 11, a second end 12, a hollow, oval cross-section 13, and directional changes 14. The channel core 10 further comprises exterior reinforcements 40. As shown in FIG. 5B, the channel core 10 has a hollow, oval cross-section 13.

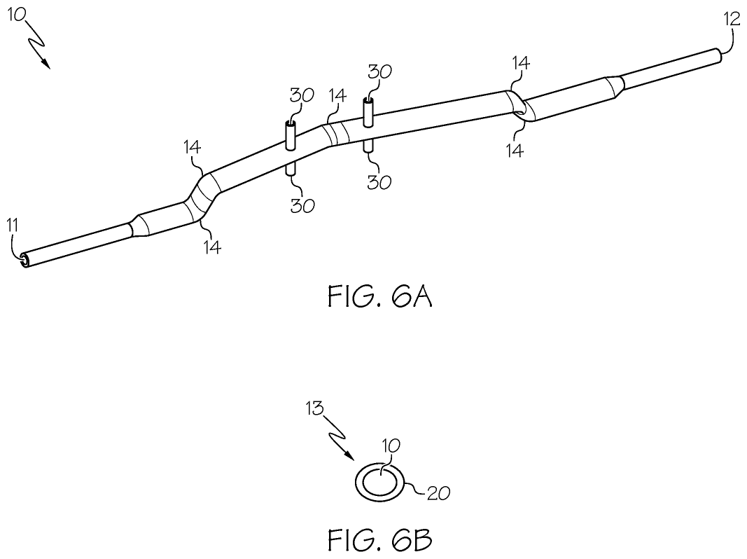

FIG. 6 is an illustration of a fourth exemplary channel core 10 according to the present description. The channel core 10 has a first end 11, a second end 12, a solid, oval cross-section 13, and directional changes 14. The channel core 10 further comprises supports 30 in the form of integrated supports.

A metal may be coated onto the channel core to form a metal tube on the channel core.

The metal used for the step of coating metal onto the channel core to form a metal tube may include any metal compatible for use with the molten metal. For example, the metal used for the step of coating metal may be the same as the molten metal or the metal used for the step of coating metal may be a component material of the molten metal.

The coating process used for coating metal onto the channel core to form a metal tube may include any process suitable for coating onto the material used to form the channel core. In particular, suitable coating processes include kinetic fusion and electroless deposition.

The thickness of the coated metal should be sufficient to withstand the molten metal such that a shape and position of the channel core is maintained during the casting step. A minimum thickness may depend on the selection of the coated metal and the selection of the molten metal.

The channel core may be positioned into a casting mold having a shape of a tool such that the channel core is positioned within the casting mold to correspond with a desired position of an internal channel of the tool. In this case, the channel core may be uncoated or may be coated with a metal. Alternatively, the channel core may be removed from the metal tube, and the metal tube may be positioned into a casting mold having a shape of a tool such that the metal tube is positioned within the casting mold to correspond with a desired position of an internal channel of the tool.

The channel core and/or metal tube may be positioned into a casting mold having a shape of a tool such that the channel core and/or metal tube is positioned within the casting mold to correspond with a desired position of a channel of the tool. The metal tube may be positioned into the cast mold while the metal tube is still coated onto the channel core, or the channel core may be removed from the metal tube prior to positioning the metal tube into the casting mold, or the channel core may be positioned into the cast mold without the metal tube. Retaining the channel core within the metal tube during the positioning and the casting may be advantageous for helping the metal tube to retain the desired position within the casting mold during the casting process. When the channel core is formed from high temperature materials, such as phenolic binder and/or refractory, the channel core may help the metal tube to retain the desired position within the casting mold during the casting process when a high temperature metal is used as the molten metal.

The channel core, such as polymer channel core, may be removed before, during, or after casting the molten metal. The channel core (e.g., polymer channel core) may be removed by, for example, melting the channel core, burning the channel core, or decomposing the channel core. By removing the channel core from the metal tube, the metal tube provides the resulting cast tool with a channel therein corresponding to the removed channel core.

Alternatively, the channel core may be formed from metal. The metal used for the channel core may include any metal compatible for use with the molten metal used in the casting step. For example, the metal used for the channel core may be the same as the molten metal or the metal used for the channel core may be a component material of the molten metal.

In an aspect, the channel core or metal tube may be supported at first and second ends by the casting mold itself. Support of the channel core or metal tube by the casting mold may be sufficient for small tools having small channels. However, for large tools having large channels, the support of the channel core or metal tube by the casting mold may be insufficient to retain the desired position of the channel core or metal tube within the casting mold, and additional supports may be included.

In an aspect, the channel core or metal tube may be supported using metal supports positioned within the casting mold. The metal supports may include any metal compatible for use with the molten metal. For example, the metal used for the metal supports may be the same as the molten metal or the metal used for the metal supports may be a component material of the molten metal. The shape of the metal supports should be sufficient to withstand the molten metal such that the channel core or metal tube is supported during the casting step. The required shape of the metal supports may depend on the selection of the metal used for the metal supports and the selection of the molten metal.

In an aspect, the channel core includes one or more integrated supports, and positioning the channel core or metal tube into the casting mold may include supporting the channel core or metal tube using the integrated supports of the channel core. The one or more integrated supports may be formed from, for example, the same material as the channel core. The one or more integrated supports may be coated during the coating step for coating the channel core. The shape of the integrated supports should be sufficient to withstand the molten metal such that the channel core or metal tube is supported during the casting step. The required shape of the integrated supports may depend on the selection of the material used for the integrated supports and the selection of the molten metal.

The molten metal used for casting may include any metal suitable for used for the resulting tool. An exemplary molten metal may include, for example, steel.

The casting mold may include any material suitable for use for a casting mold for the selected molten metal, such as a die mold. An exemplary casting mold may include a sand casting mold.

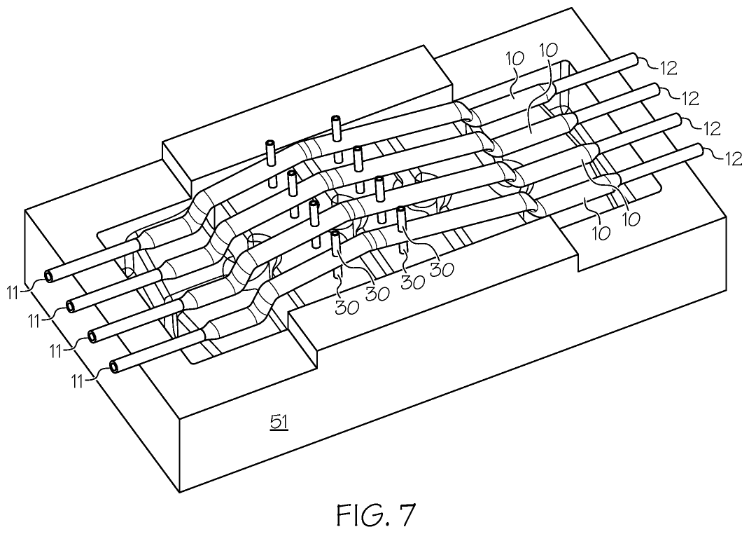

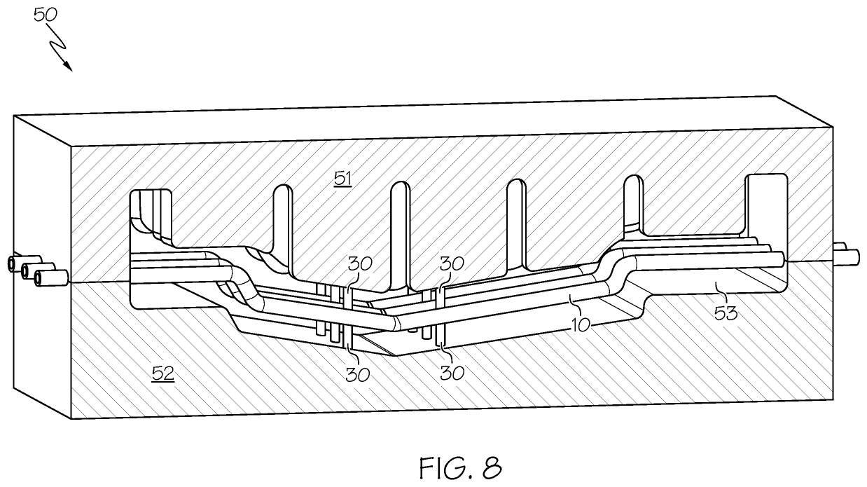

FIGS. 7 to 9 illustrate exemplary casting molds 50 according to the present description. The present description includes these casting molds as well as variations therefrom.

FIGS. 8 and 8 are illustrations of a first exemplary casting mold 50 according to the present description.

Referring to FIGS. 7 and 8, the casting mold 50 includes a first mold portion 51 and a second mold portion 52, having a cavity 53. The metal tube 20, with channel core 10 removed or not removed, is positioned into the casting mold 50 having the shape of the tool. The metal tube 20 is supported by supports 30 in the form of integrated supports to retain the metal tube 20 in the desired position within the casting mold 50.

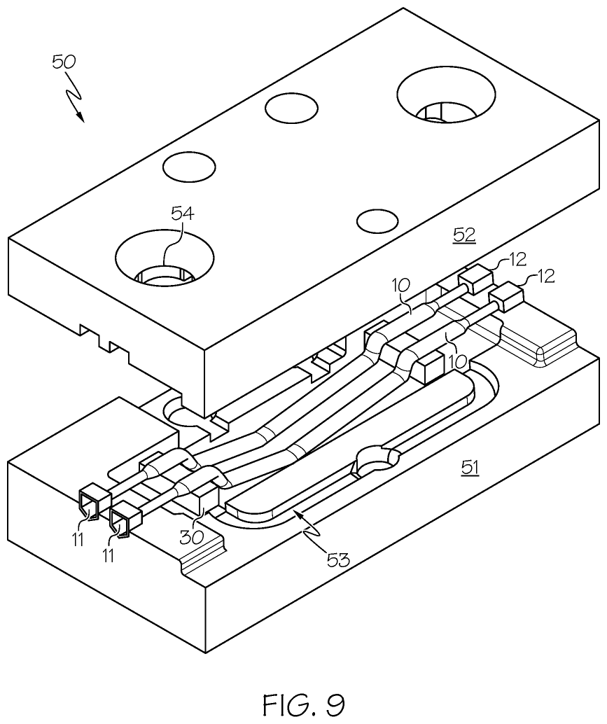

FIG. 9 is an illustration of a second exemplary casting mold according to the present description.

Referring to FIG. 9, the casting mold 50 includes a first mold portion 51 and a second mold portion 52, having a cavity 53. The metal tube 20, with channel core 10 removed or not removed, is positioned into the casting mold 50 having the shape of the tool. The metal tube 20 is supported by supports 30 in the form of supports 30 in the form of metal supports that are separate from the channel core to retain the metal tube 20 in the desired position within the casting mold 50.

The method of the present description may be used to form a tool. The material used for forming a tool body of the tool may include any material suitable for used for the desired application for the tool. An exemplary tool body material may include, for example, steel.

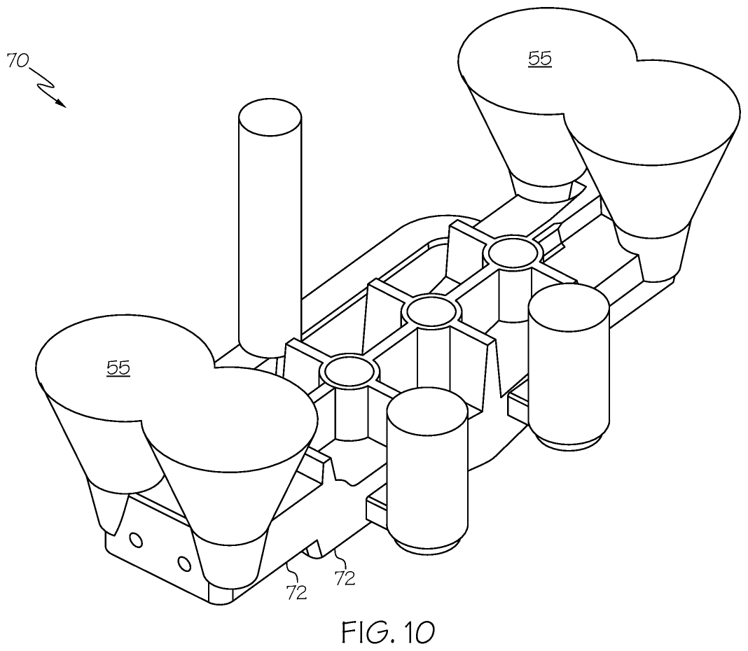

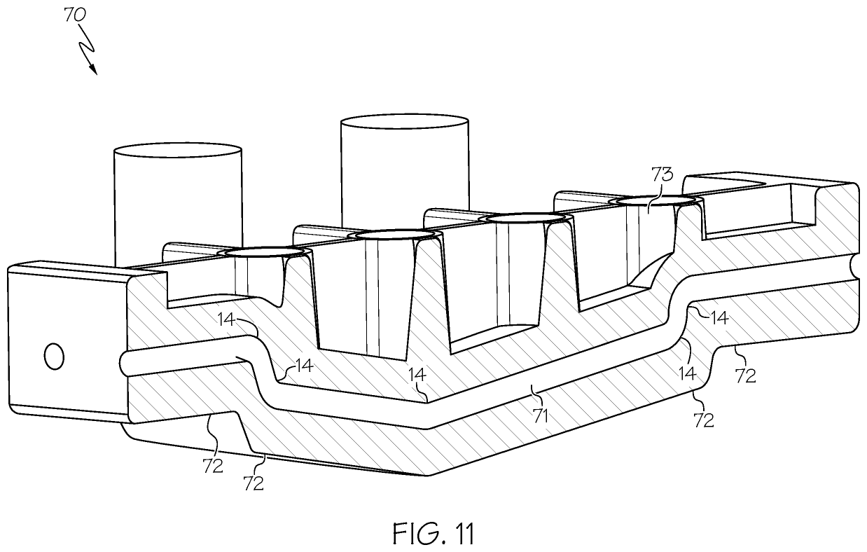

FIG. 10 is an illustration of an exemplary tool according to the present description. FIG. 11 is a cross section of the tool of FIG. 10. The tool 70 of FIGS. 10 and 11 include a tool body 73 having a surface contour 72 and a conforming internal channel 71 having one or more directional changes 14 and following the surface contour of the surface 72 of the tool 70. The internal channel 71 is provided within tool 70 to improve heating or cooling. By way of the internal channel 71 conforming to the surface contour 72 of the tool 70, a conformal approach may be used to improve heating or cooling by providing more uniform heating or cooling of the tool 70. Novel features of the present description include the use of low cost techniques that when combined offer a robust solution to conformal heating or cooling. The present description is further valuable as a way to reduce tooling cost and increase the performance of composite tooling.

Although various examples of the disclosed tools having internal channels and methods for manufacturing tools have been shown and described, modifications may occur to those skilled in the art upon reading the specification. The present application includes such modifications and is limited only by the scope of the claims.

1. A method for manufacturing a tool having one or more internal channels, the method comprising:
forming, by additive manufacturing, one or more channel cores comprising an inorganic material and having one or more directional changes and one or more integrated supports;
coating a metal onto the one or more channel cores to form a metal tube on each of the one or more channel cores;
positioning the one or more metal tubes into a casting mold having a shape of a tool, wherein positioning the one or more metal tubes into the casting mold comprises supporting the one or more metal tubes using the integrated supports of the one or more channel cores; and
casting a molten metal into the casting mold to form the tool having the one or more internal channels corresponding to the one or more channel cores.

2. The method of claim 1, wherein forming the one or more channel cores by additive manufacturing comprises forming the one or more channel cores comprising a polymer binder by additive manufacturing.

3. The method of claim 1, wherein forming the one or more channel cores by additive manufacturing comprises forming the one or more channel cores comprising a phenolic binder by additive manufacturing.

4. The method of claim 1, wherein the inorganic material comprises a refractory.

5. The method of claim 1, wherein the inorganic material comprises a ceramic sand.

6. The method of claim 1, wherein forming the one or more channel cores by additive manufacturing comprises forming the one or more channel cores having a round cross-section by additive manufacturing.

7. The method of claim 1, wherein forming the one or more channel cores by additive manufacturing comprises forming the one or more channel cores having an oval cross-section by additive manufacturing.

8. The method of claim 1, wherein forming the one or more channel cores by additive manufacturing comprises forming one or more channel cores having a solid cross-section by additive manufacturing.

9. The method of claim 1, wherein forming the one or more channel cores by additive manufacturing comprises forming the one or more channel cores having a hollow cross-section by additive manufacturing.

10. (canceled)

11. The method of claim 1, wherein forming the one or more channel cores by additive manufacturing comprises forming the one or more channel cores having one or more exterior reinforcements by additive manufacturing.

12. The method of claim 1, wherein coating the metal onto the one or more channel cores to form the metal tube comprises coating the metal onto the one or more channel cores by kinetic fusion or electroless deposition.

13. The method of claim 1, wherein positioning the one or more metal tubes into the casting mold comprises supporting the one or more metal tubes using supports.

14. The method of claim 1, wherein positioning the one or more metal tubes into the casting mold comprises supporting the one or more metal tubes using metal supports that are separate from the one or more metal tubes.

15. (canceled)

16. The method of claim 1, wherein casting the molten metal into the casting mold to form the tool having the one or more internal channels corresponding to the one or more channel cores comprises melting an outermost portion of the one or more metal tubes, wherein an innermost portion of the one or more metal tubes remains solid during the step of casting the molten metal.

17. The method of claim 1, further comprising removing the one or more channel cores before casting the molten metal.

18. The method of claim 1, further comprising removing the one or more channel cores during casting the molten metal.

19. (canceled)

20. A method for manufacturing a tool having one or more internal channels, the method comprising:
forming one or more channel cores by additive manufacturing, wherein the forming the one or more channel cores by additive manufacturing comprises forming the one or more channel cores comprising an inorganic material by additive manufacturing;
positioning the one or more channel cores into a casting mold having a shape of a tool; and
casting a molten metal into the casting mold to form the tool having the one or more internal channels corresponding to the one or more channel cores.

21-34. (canceled)

35. A tool, comprising:
a tool body comprising a surface, the surface comprising a surface contour; and
a conforming internal channel having one or more directional changes and following the surface contour of the surface of the tool.

36. The method of claim 1, wherein the one or more channels are one or more conformal channels that conform to a contour of a surface of the tool.

37. The method of claim 1, positioning the one or more metal tubes into the casting mold comprises contacting the integrated supports of the one or more channel cores with a surface of the casting mold.
